(19) United States
(12) Patent Application Publication
(10) Pub. No.: US 2026/0358159 A1
(43) Pub. Date: Nov. 12, 2026

(54) CLOSED LOOP STARTUP IN A MAGNETIC FLOWMETER

(71) Applicant: Micro Motion, Inc., Boulder, CO (US)

(72) Inventors: Scot Ronald Foss, Eden Prairie, MN (US); Kyle Joseph McBrady, Maple Plain, MN (US)

(21) Appl. No.: 19/453,366

(22) Filed: Jan. 20, 2026

Related U.S. Application Data
(60) Provisional application No. 63/802,049, filed on May 8, 2025.

(51) Int. Cl. G01F 1/60; G01F 1/58

(52) U.S. Cl. CPC G01F 1/60; G01F 1/584; G01F 1/586

(57) ABSTRACT

A magnetic flowmeter for measuring flow rate of a process fluid includes a flow tube arranged to receive a flow of the process fluid therethrough. A magnetic coil is arranged proximate the flow tube to apply a magnetic field to the process fluid flowing through the flow tube. A pair of electrodes are electrically coupled to the process fluid in the flow tube and arranged to sense a voltage induced in the process fluid related to the applied magnetic field and a flow rate of the process fluid. Flowmeter circuitry is configured to apply an electric current to the magnetic coil and receive the voltage sensed by the pair of electrodes. During startup of the magnetic flowmeter, a closed feedback loop is used to control the electric current applied to the magnetic coil to adapt to electrical properties of the magnetic coil.

### CROSS-REFERENCE TO RELATED APPLICATION

The present application is based on and claims the benefit of U.S. provisional patent application Serial No. 63/802,049, filed May 8, 2025, the content of which is hereby incorporated by reference in its entirety.

### BACKGROUND

Embodiments of the present disclosure relate to magnetic flowmeters and, more specifically, to techniques for implementing closed loop startup in a magnetic flowmeter.

Precise and accurate flow control is desirable for a wide range of fluid processing applications, including bulk fluid handling, food and beverage preparation, chemistry and pharmaceuticals, water and air distribution, hydrocarbon extraction and processing, environmental control, and a range of manufacturing techniques utilizing thermoplastics, thin films, glues, resins and other fluid materials, for example. Flow rate measurement technologies used in each particular application depend upon the fluids involved, and on the relevant process pressures, temperatures and flow rates.

Exemplary flow rate measuring technologies include turbine devices that measure flow as a function of mechanical rotation, pitot sensors and differential pressure devices that measure flow as a function of the Bernoulli effect or pressure drop across a flow restriction, vortex and Coriolis devices that measure flow as a function of vibrational effects, and mass flowmeters that measure flow as a function of thermal conductivity. Magnetic flowmeters are distinguished from these technologies by characterizing a flow based on Faraday's Law, which depends upon electromagnetic interactions rather than mechanical or thermodynamic effects. In particular, magnetic flowmeters rely upon the conductivity of the process fluid, and the electromotive force (EMF) induced as the fluid flows through a region of magnetic field. Magnetic flowmeters function by creating a magnetic field inside a pipe using external coils. Flow is measured using electrodes to measure a voltage as the liquid flows. The voltage generated is proportional to the velocity of the liquid.

In order to improve operation of a magnetic flowmeter sensor, control electronics of the magnetic flowmeter sensor is configured based upon electrical properties of a coil that it is driving. In the past, an open loop startup has been used to probe the coil in order to obtain the electrical properties of the coil. The open loop start technique applies a gradually increasing voltage to the coil until a target current flowing through the coil is reached. Once the electrical properties of the coil are known and the control electronics of the flowmeter is configured based on those properties, closed loop control can begin, which allows flow rate to be accurately measured. However, on large inductive loads, this process can take many seconds to complete.

### SUMMARY

A magnetic flowmeter for measuring flow rate of a process fluid includes a flow tube arranged to receive a flow of the process fluid therethrough. A magnetic coil is arranged proximate the flow tube to apply a magnetic field to the process fluid flowing through the flow tube. A pair of electrodes are electrically coupled to the process fluid in the flow tube and arranged to sense a voltage induced in the process fluid related to the applied magnetic field and a flow rate of the process fluid. Flowmeter circuitry is configured to apply an electric current to the magnetic coil and receive the voltage sensed by the pair of electrodes. During startup of the magnetic flowmeter, a closed feedback loop is used to control the electric current applied to the magnetic coil to adapt to electrical properties of the magnetic coil.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an exemplary industrial process measurement system in accordance with embodiments of the present disclosure.

FIG. 2 is a graph of current versus time for current applied to a coil of a magnetic flowmeter in accordance with a prior art configuration.

FIG. 3 is a simplified block diagram of adaptive digital coil drive circuitry that implements a closed loop startup in a magnetic flowmeter in accordance with an embodiment of the present disclosure.

FIG. 4 is a graph of current versus time for current applied to a coil of a magnetic flowmeter in accordance with a closed loop startup sequence of the present disclosure.

FIG. 5 is a simplified schematic diagram of coil driver circuitry for driving a coil in a magnetic flowmeter in accordance with an embodiment of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations. The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form, in order to avoid obscuring the embodiments in unnecessary detail.

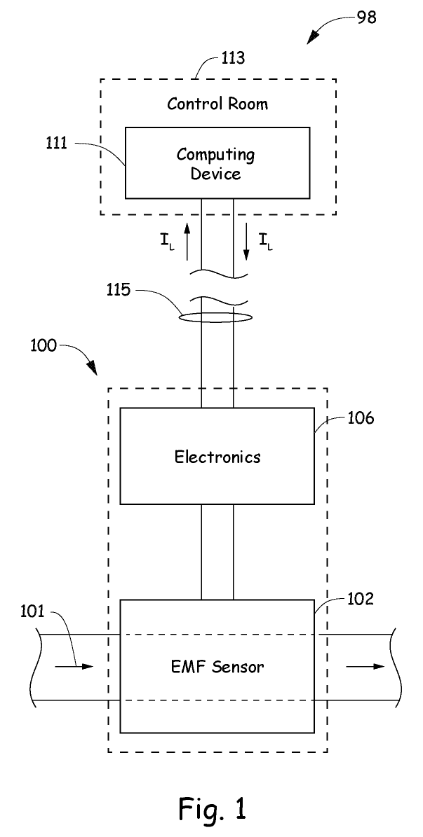

Magnetic flowmeters function by creating a magnetic field inside a pipe using external coils. Flow is measured using electrodes to measure a voltage as the liquid flows. The voltage generated is proportional to the velocity of the liquid. Magnetic flowmeters typically use a generic digital coil driver circuit. Due to the generic digital coil driver, the ideal controller gains are not available at power up of the device and need to be calculated to provide optimal coil current settling time. In order to calculate the gains, the electrical properties of the coil need to be discovered. In the past, an open loop startup sequence has been used to discover the electrical properties by applying a gradually increasing voltage to the coil and waiting for coil current to achieve a setpoint. After the setpoint is achieved, the electrical properties of the coil can be calculated and a closed loop control technique can begin which allows flow rate to be accurately measured. However, on large inductive loads, this process can take several seconds to complete. To address this problem, embodiments of the disclosure employ a closed loop startup that reduces or eliminates such delays in measuring flow rate upon startup. Prior to providing specific implementation details regarding the closed loop startup, an industrial process management system is described below in connection with FIG. 1.

FIG. 1 is a simplified diagram of an exemplary industrial process measurement system 98, in accordance with embodiments of the present disclosure. The system 98 may be used in the processing of a material (e.g., process medium) to transform the material from a less valuable state into more valuable and useful products, such as chemicals, paper, food, etc. In general, the system 98 may be used with a wide variety of conductive fluids, which are generally characterized as liquids containing dissolved ions that can conduct electricity.

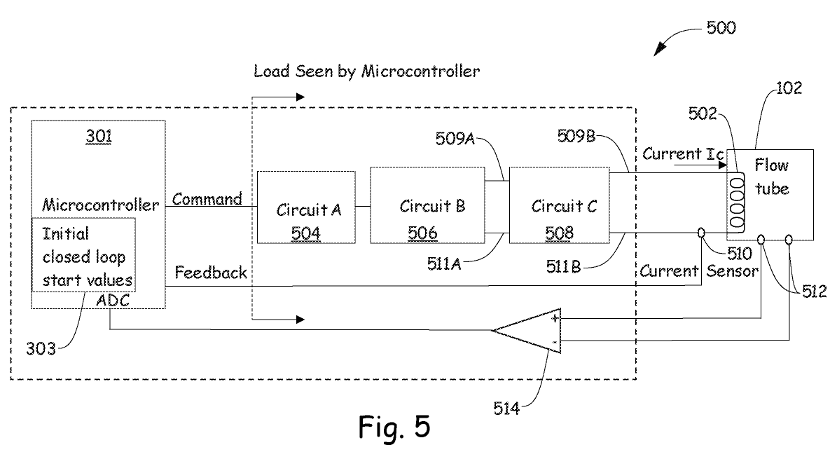

The system 98 includes a pulsed direct current (DC) magnetic flowmeter 100 that is configured to sense a flow rate of a process fluid flow 101, such as through a pipe or flow tube 102, for example. The magnetic flowmeter 100 includes an electromotive force (EMF) sensor 512 (see FIG. 5) and flowmeter electronics 106. The sensor 512 is generally configured to measure or sense the flow rate of the fluid flow 101. The electronics 106 are generally configured to control the applied magnetic field to measure the flow rate, and optionally communicate the measured flow rate to an external computing device 111, such as a computerized control unit, which may be remotely located from the flowmeter 100, such as in a control room 113 of the system 98.

The electronics 106 may communicate with the external computing device 111 over a suitable process control loop. In some embodiments, the process control loop includes a physical communication link, such as a two-wire control loop 115, or a wireless communication link. Communications between the external computing device 111 and the flowmeter 100 may be performed over the control loop 115 in accordance with conventional analog and/or digital communication protocols. In some embodiments, the two-wire control loop 115 includes a 4-20 milliamp control loop, in which a process variable may be represented by a level of a loop current I_{L} flowing through the two-wire control loop 115. Exemplary digital communication protocols include the modulation of digital signals onto the analog current level of the two-wire control loop 115, such as in accordance with the HART® communication standard. Other purely digital techniques may also be employed including Foundation Fieldbus and Profibus communication protocols or Ethernet APL. Exemplary wireless versions of the process control loop include, for example, a wireless mesh network protocol, such as WirelessHART® (IEC 62591) or ISA 100.11a (IEC 62734), or another wireless communication protocol, such as WiFi, LoRa, Sigfox, BLE, or any other suitable protocol.

Power may be supplied to the magnetic flowmeter 100 from any suitable power source. For example, the magnetic flowmeter 100 may be wholly powered by the loop current I_{L} flowing through the control loop 115. One or more power supplies may also be utilized to power the process magnetic flowmeter 100, such as an internal or an external battery. An electrical power generator (e.g., solar panel, a wind power generator, etc.) may also be used to power the magnetic flowmeter 100, or charge a power supply used by the magnetic flowmeter 100.

As noted above, magnetic flowmeters such as 100 function by creating a magnetic field inside a pipe or flow tube 102 using one or more external coils 502 (see FIG. 5). Flowmeter electronics 106 is electrically coupled to coil 502 and EMF sensor 512, which is used to measure a voltage as the liquid flows through tube 102.

Flowmeter electronics 106 may include one or more processors that control components of the magnetic flowmeter 100 to perform one or more functions described herein in response to the execution of instructions, which may be stored in non-transitory memory. In some embodiments, the control components provide control signals to current generation circuitry, which may also be part of flowmeter electronics 106, based on an operating setpoint of the magnetic flowmeter 100, to generate a coil current I_{C} comprising, for example, DC current pulses (e.g., square wave current pulses) that alternate direction through the coil 502. Other types of alternating coil currents may also be used.

The current generation circuitry may periodically receive current level measurements of the coil current I_{C} from current sensing or sampling circuitry as feedback to determine if an adjustment to the coil current I_{C} is required to match the setpoint level for the magnetic flowmeter 100, which is necessary for accurate flow rate measurements. The current sampling circuitry may take on any suitable form. For example, the current sampling circuitry may operate to sense a voltage that is related to the coil current I_{C} and convert the sampled voltage to a digital signal using an analog-to-digital converter that is part of control circuitry, for example. The control circuitry may adjust the coil current I_{C} based on the measured current level in an attempt to match the current level of the coil current I_{C} to the setpoint current level directed by the operating setpoint of the magnetic flowmeter 100.

The coil current I_{C} is delivered to the coil 502 of the flow tube 102 through a suitable electrical connection. This causes the coil 502 to generate a magnetic field in the flow tube 102 that changes direction at a desired excitation frequency. The process fluid flow 101 traveling through the interior of the flow tube 102 functions as a moving conductor that induces EMF in the fluid in accordance with Faraday’s law of electromagnetic induction. The EMF sensor 512, which may include electrode components that provide a capacitive coupling to the conductive process fluid or a direct electrical coupling to the conductive process fluid, pick up the voltages present in the fluid flow 101. The difference in the voltages at the electrodes of EMF sensor 512 is proportional to the rate of the fluid flow 101.

A signal processor, which may be part of flowmeter electronics 106, may sample the voltage difference between the electrodes of the EMF sensor 512, and provide the measured voltage difference to a digital processor, which may also be part of control electronics 106, using any suitable technique. This may involve converting an analog differential voltage signal to a digital value that is supplied to the digital processor, for example. The digital processor may perform further signal processing of the measured differential voltage to establish a flow rate measurement of the flow rate of the process fluid flow 101. The measured flow rate may be communicated to the computing device 111 through one of the wired or wireless communication protocols discussed above.

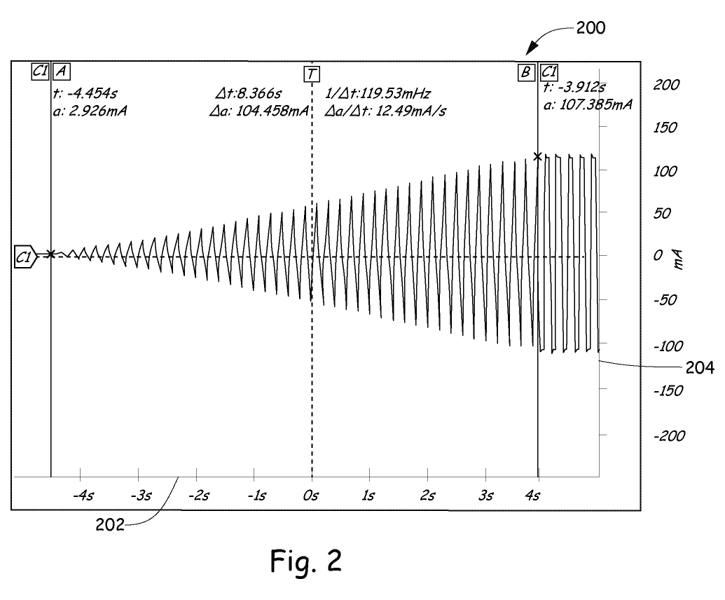

As noted earlier, in the past, magnetic flowmeters employed an open loop startup process. In one prior art open loop startup process, a step voltage input is applied to the coil. By monitoring the rise time of the resultant current using a current sensor, the inductance of coil is determined, as well as the value of any parasitic resistance. The loop is then closed using the initially calculated tuning parameters. Such an open loop process can take several seconds and can therefore cause a delay in commencing flow rate measurements. An example of such a delay is provided below in connection with FIG. 2.

FIG. 2 is a graph 200 of current versus time for current applied to a coil of a magnetic flowmeter in accordance with a prior art configuration. In FIG. 2, horizontal axis 202 represents time in in seconds (s) and vertical axis 204 represents current in milliamperes (mA). FIG. 2 shows the process of achieving a setpoint on a 2.6 Henry (H) inductive load. As can be seen in FIG. 2, the open loop startup process begins prior to time -4s and flow measurements can begin at approximately 4s, which indicates that the process takes over eight seconds before flow measurements can commence.

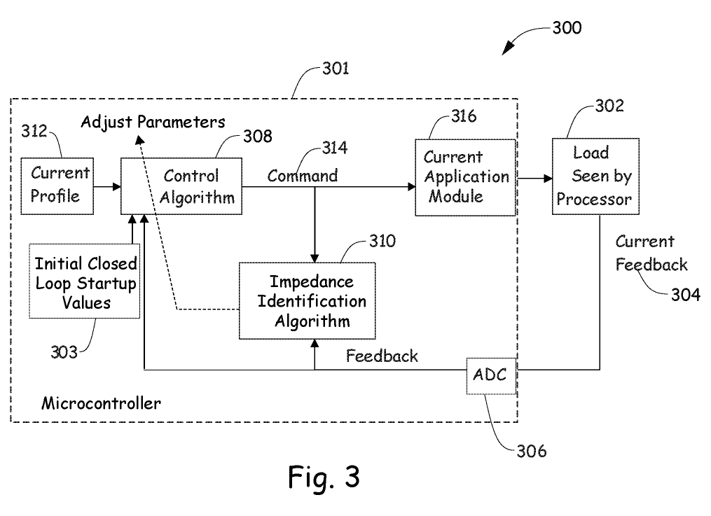

FIG. 3 is a simplified block diagram of adaptive digital coil driver circuitry 300 of a magnetic flowmeter that employs closed loop startup in accordance with an embodiment of the disclosure. The diagram of FIG. 3 illustrates microcontroller 301 coupling to a “load” 302 which is the effective load from a coil 502 (of FIG. 5) along with other circuit components (e.g., 504, 506 and 508 of FIG. 5) in the current path as seen by the microcontroller circuitry 301. In order to increase the speed of the startup sequence, instead of employing an open loop startup as described above in connection with FIG. 2, microprocessor 301 employs a closed loop startup sequence. This technique assumes that an initial load seen by microprocessor 301 at startup is a small load, similar to a calibrator. An example of such a small load value is a 4.8 millihenry (mH) inductance and 1 ohm impedance. It should be noted that the small load values may change depending on magnetic flowmeter designs. In general, the small load values are selected to provide stability during startup across a range of magnetic flowmeter sensor inductances and resistances. For example, these values can be chosen to allow startup in a closed loop with very small inductors (such as 0.5mH and 0.5ohm) while still providing enough power to large inductors (such as 5H and 42ohm) to generate a current signal that can be accurately detected by current sense circuitry, which may include a current sensor such as 510 and an ADC such as 306. The assumed, predetermined or preselected value or values for the small load may be stored in a suitable memory within microcontroller circuitry 301. In FIG. 3, these initial closed loop startup values are designated by reference numeral 303.

Current through load 302 is sensed by sensor 510 (see FIG. 5) which provides the current feedback 304. The sensed current feedback 304 is converted into a digital value using analog to digital converter 306 and is applied to a control algorithm 308 and an impedance identification algorithm 310. The control algorithm 308 operates in accordance with a selected current profile 312 to control operation of circuits such as 504, 506 and 508 shown in FIG. 5, via current application module 316. The control algorithm provides command signals 314 to current application module 316 and to the impedance identification algorithm 310. The impedance identification algorithm 310 determines electrical properties of the load 302 by comparing the digitized current feedback 304 with the command signal 314 provided by the control algorithm 308. Based upon the identified electrical properties by the impedance identification algorithm 310, the impedance identification algorithm 310 adjusts the control parameters used by the control algorithm 308 to adapt to the specific electrical properties provided by load 302. The electrical properties may include an inductance, a DC resistance and an inductive reactance of the magnetic coil (e.g., coil 502 of FIG. 5).

In operation, upon power up, a closed loop startup sequence is employed as indicated earlier. The system starts running in a closed loop control mode using initial closed loop startup values 303, and with the help of impedance measurements uses real-time adaptive control algorithm 308 to tune the controller gains to be appropriate for the sensor load. Due to the Intrinsic Safety barrier used in some flowmeters, there may be a limit to the power budget available to the coil driver. Thus, a short predetermined setpoint ramp rate may be implemented to prevent over drawing power from the power supply. In one example, a one second setpoint ramp rate was implemented to prevent over drawing power from the power supply. These two aspects allow a closed loop start up sequence to complete, and the flowmeter is able to start flow measurements rapidly (e.g., within one second when a one second setpoint ramp rate is used), regardless of what sensor load is connected to the electronics of the flowmeter. The closed loop start sequence allows for the open loop startup process used in the past to be skipped, and flow measurement can begin more rapidly. The configuration allows a generic digital coil driver to start rapidly, regardless of sensor load that it is driving. The configuration can be implemented in any device that uses an adaptive controller.

The electrical properties of the magnetic coil may change over time due to environment (such as the temperature of the flow tube 102), while operating in closed loop, the impedance identification algorithm 310 continuously measures the electrical properties of the magnetic coil. After passing the new electrical properties through a low pass filter, the microcontroller 301 calculates the new optimum control loop parameters for the implemented control scheme. In this way, the magnetic flowmeter coil driver continuously operates at or near optimum performance.

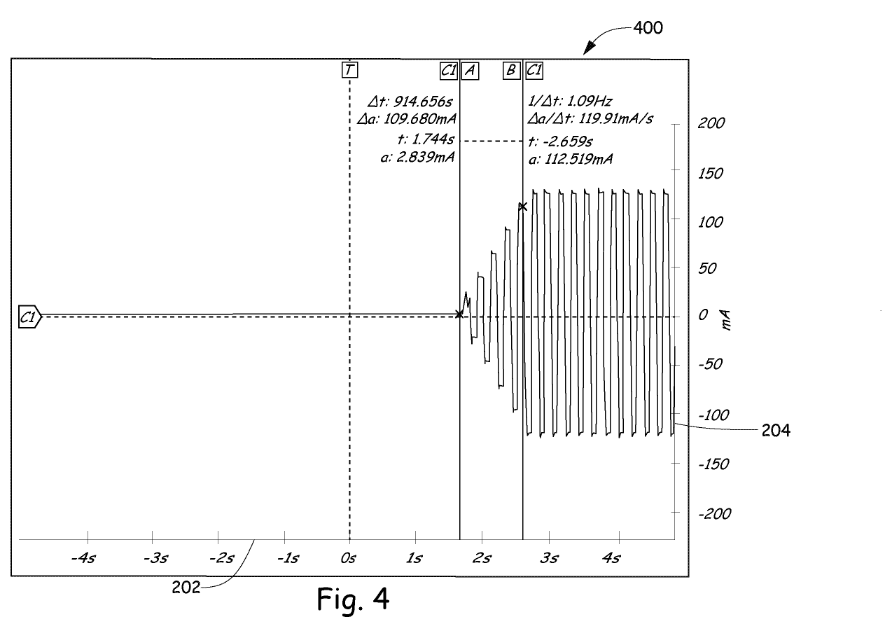

FIG. 4 is a graph 400 of current versus time for current applied to a coil (e.g., 502 of FIG. 5) of a magnetic flowmeter in accordance with a closed loop startup sequence of the present disclosure. In FIG. 4, horizontal axis 202 and vertical axis 204 are the same as those of FIG. 2. FIG. 4 shows the closed loop startup process on a 2.6H inductive load, which is the same as the load employed for the open loop startup process for obtaining the results in FIG. 2. As can be seen in FIG. 4, the closed loop startup process begins at approximately 1.8s and flow measurements can begin at approximately 2.8s, thereby allowing flow measurements to commence in about one second. It should be noted that, although a 2.6H load is employed in the example of FIG. 2, the closed loop startup sequence allows for flow measurements to begin in a short period time (e.g., in one second) regardless of what sensor load is connected to the electronics.

FIG. 5 is a simplified schematic diagram of coil driver circuitry 500 for driving a coil in a magnetic flowmeter in accordance with an embodiment of the disclosure. As noted earlier in connection with FIG. 3, microcontroller 301 employs initial closed loop startup values 303 at startup, and the load seen by microcontroller 301 includes the load from a coil 502 along with current supply circuitry that may include any suitable number of sub-circuits or circuit components represented by blocks 504, 506 and 508, for example, in FIG. 5. Current supply circuitry (e.g., sub-circuits 504, 506 and 508) receives commands from microcontroller 301 and provides current to coil 502 in accordance with the received commands. In one embodiment, sub-circuit 506 may include a H Bridge driver that is connected between a bus voltage and electrical ground and that includes multiple switches that may be field effect transistors or the like. In such an embodiment, sub-circuit 504 may include switch drivers that are connected to the multiple switches of the H bridge. In the interest of simplification, switch drivers are not shown within sub-circuit 504 and H bridge switches are not shown within sub-circuit 506. The switch drivers receive commands from microcontroller 301 and H bridge switches are controlled such that the H bridge outputs high frequency current pulses, which are delivered to a low pass filer (LPF) of circuit 508 that operates to attenuate the high frequency to provide low frequency coil current pulses that form the coil current that is delivered through the coil 502.

In one embodiment, the microcontroller 301 controls the direction the filtered coil current flows through the coil 502 by modulating a duty cycle of the H bridge switches of sub-circuit 506. Different control signals from the microcontroller 301 to the H bridge switches cause the coil current to flow in opposing directions through the coil 502. In general, a series of narrow (short duration, low duty cycle) pulses provided to a selected subset of the H bridge switches will cause corresponding short current pulses in one of lines 509A or 511A based on the switch selection. When these high frequency short current pulses are passed through the LPF of sub-circuit 508, the result is a low DC voltage on the corresponding line 509B or 511B. Similarly, a series of wide (long duration, high duty cycle) pulses will cause a high DC voltage to be applied to the corresponding line 509A or 511A. When these high frequency long current pulses are passed through the LPF of sub-circuit 508, the result is a high DC voltage on the corresponding line 509B or 511B. For example, actuation of a particular subset the H bridge switches by the microcontroller 301 causes the average voltage in the line 509B to be greater than the average voltage in line 511B, resulting in the coil current Ic flowing in the direction indicated in FIG. 5. Actuation of a different subset the H bridge switches by the microcontroller 301 causes the average voltage in the line 509B to be greater than the average voltage in line 511B, resulting in the coil current flowing in the opposite direction from that indicated in FIG. 5. Thus, by controlling the pulse width modulation command signals applied to the H Bridge of sub-circuit 506, the microcontroller 301 can control the amplitude, rate of change, and shape of the current signal applied to the coil 502. Such circuitry is described further in co-owned U.S. patent application Ser. No. 16/587,615, filed Sep. 30, 2019, entitled “CONTINUOUSLY ADAPTIVE DIGITAL COIL DRIVER FOR MAGNETIC FLOWMETER”, and patented as U.S. Pat. No. 11,204,267 on Dec. 21 , 2021, each incorporated herein by reference in its entirety.

A current sensor 510 is used to sense the current applied to the coil 502. This sensed current provides a feedback signal to an analog to digital converter (ADC) of microcontroller 301. The current sensor 510 can be in accordance with any appropriate technology such as a measured voltage drop across a series resistance.

FIG. 5 also illustrates EMF sensors 512 which are electrically coupled to the fluid in the flow tube 102 and may comprise, for example, electrodes. As noted above, the EMF sensors 512, which may include electrode components that provide a capacitive coupling to the conductive process fluid or a direct electrical coupling to the conductive process fluid, pick up the voltages present in the fluid flow 101. The difference in the voltages at the electrodes of EMF sensor 512 is proportional to the rate of the fluid flow 101. A differential amplifier 514 receives output signals from the EMF sensors 512 and provides an amplified differential signal to the ADC of microcontroller 301. Microprocessor 301 may perform further signal processing of the measured differential voltage to establish a flow rate measurement of the flow rate of the process fluid flow 101. As indicated above, the measured flow rate may be communicated to the computing device 111 through one of the wired or wireless communication protocols discussed above.

Although the present invention has been described with reference to preferred embodiments, workers skilled in the art will recognize that changes may be made in form and detail without departing from the spirit and scope of the invention.

What is claimed is:

1. A magnetic flowmeter for measuring flow rate of a process fluid, comprising:
a flow tube arranged to receive a flow of the process fluid therethrough;
a magnetic coil arranged proximate the flow tube to apply a magnetic field to the process fluid flowing through the flow tube;
a pair of electrodes electrically coupled to the process fluid in the flow tube and arranged to sense a voltage induced in the process fluid related to the applied magnetic field and a flow rate of the process fluid;
flowmeter circuitry configured to apply an electric current to the magnetic coil and receive the voltage sensed by the pair of electrodes; and
wherein during startup, a closed feedback loop is used to control the electric current applied to the magnetic coil to adapt to electrical properties of the magnetic coil.

2. The magnetic flowmeter of claim 1 wherein the electrical properties comprise at least one of an inductance, a direct current (DC) resistance or an inductive reactance of the magnetic coil.

3. The magnetic flowmeter of claim 1 wherein the flowmeter circuitry comprises a digital control circuit configured to implement the closed feedback loop during startup by employing at least one preselected initial closed loop startup value that represents an initial electrical load placed on the flowmeter circuitry.

4. The magnetic flowmeter of claim 3 wherein the digital control circuit is configured to implement a predetermined setpoint ramp rate.

5. The magnetic flowmeter of claim 4 wherein the predetermined setpoint ramp rate is 1 second.

6. The magnetic flowmeter of claim 3 wherein the digital control circuit is configured to provide a command input to current supply circuitry that provides the electric current to the magnetic coil as a function of the command input.

7. The magnetic flowmeter of claim 6 wherein the digital control circuit is configured to provide the command input to the current supply circuitry as a function of a control algorithm.

8. The magnetic flowmeter of claim 7 wherein the control algorithm is configured to generate the command input as a function of a sensed current flowing through the magnetic coil.

9. The magnetic flowmeter of claim 8 wherein the digital control circuit comprises an impedance identification algorithm configured to identify the electrical properties of the magnetic coil as a function of the sensed current and the command input and responsively control parameters of the control algorithm.

10. A method for measuring flow of a process fluid using a magnetic flowmeter, comprising:
receiving a flow of the process fluid through a flow tube;
applying, by a magnetic coil arranged proximate the flow tube, a magnetic field to the process fluid flowing through the flow tube;
sensing, by a pair of electrodes electrically coupled to the process fluid in the flow tube, a voltage induced in the process fluid related to the applied magnetic field and a flow rate of the process fluid;
applying, by flowmeter circuitry, an electric current to the magnetic coil and receiving the voltage sensed by the pair of electrodes; and
employing a closed feedback loop during startup to control the electric current applied to the magnetic coil to adapt to electrical properties of the magnetic coil.

11. The method of claim 10 wherein the electrical properties comprise at least one of an inductance, a direct current (DC) resistance or an inductive reactance of the magnetic coil.

12. The method of claim 10 and further comprising providing, by a digital control circuit of the flowmeter circuitry, the closed loop feedback during startup by employing at least one preselected initial closed loop startup value that represents an initial electrical load placed on the flowmeter circuitry.

13. The method of claim 12 and further comprising implementing, by the digital control circuit, a predetermined setpoint ramp rate.

14. The method of claim 13 wherein the predetermined setpoint ramp rate is 1 second.

15. The method of claim 12 and further comprising providing, by the digital control circuit, a command input to current supply circuitry that provides the electric current to the magnetic coil as a function of the command input.

16. The method of claim 15 and further comprising providing, by the digital control circuit, the command input to the current supply circuitry as a function of a control algorithm.

17. The method of claim 16 and further comprising generating, by the control algorithm, the command input as a function of a sensed current flowing through the magnetic coil.

18. The method of claim 17 and further comprising identifying, by an impedance identification algorithm of the digital control circuit, the electrical properties of the magnetic coil as a function of the sensed current and the command input and responsively controlling, by the impedance identification algorithm, parameters of the control algorithm.

19. A magnetic flowmeter for measuring flow rate of a process fluid, comprising:
a flow tube arranged to receive a flow of the process fluid therethrough;
a magnetic coil arranged proximate the flow tube to apply a magnetic field to the process fluid flowing through the flow tube;
a pair of electrodes electrically coupled to the process fluid in the flow tube and arranged to sense a voltage induced in the process fluid related to the applied magnetic field and a flow rate of the process fluid; and
flowmeter circuitry configured to apply an electric current to the magnetic coil and receive the voltage sensed by the pair of electrodes,
wherein the flowmeter circuitry comprises a digital control circuit configured to implement a predetermined setpoint ramp rate during startup.

20. The magnetic flowmeter of claim 19 wherein the digital control circuit is further configured to implement a closed feedback loop during startup by employing at least one preselected initial closed loop startup value that represents an initial electrical load placed on the flowmeter circuitry.
